(19) United States
(12) Patent Application Publication
(10) Pub. No.: US 2023/0397040 A1
(43) Pub. Date: Dec. 7, 2023

(54) COMMUNICATION METHOD AND APPARATUS APPLIED TO REMOTE DRIVING, MEDIUM, AND ELECTRONIC DEVICE

(71) Applicant: Tencent Technology (Shenzhen) Company Limited, Shenzhen (CN)

(72) Inventor: Yixue LEI, Shenzhen (CN)

(73) Assignee: Tencent Technology (Shenzhen) Company Limited, Shenzhen (CN)

(21) Appl. No.: 18/236,258

(22) Filed: Aug. 21, 2023

Related U.S. Application Data
(63) Continuation of application No. PCT/CN2022/095144, filed on May 26, 2022.

(30) Foreign Application Priority Data
Jul. 1, 2021 (CN) 202110749253.9

(51) Int. Cl. H04W 28/02; H04W 76/10

(52) U.S. Cl. CPC H04W 28/0268; H04W 76/10

(57) ABSTRACT

In a method for remotely controlling a vehicle, protocol data unit (PDU) session parameter information corresponding to a plurality of remote control modes of the vehicle is obtained by a session management function entity. The plurality of remote control modes includes a first remote control mode and a second remote control mode. While the vehicle is controlled according to the PDU session parameter information corresponding to the first remote control mode, mode switching information is received from an application function entity by the session management function entity. The mode switching information indicates the first remote control mode is to be switched to the second remote control mode. Based on the mode switching information, the vehicle is controlled by the session management function entity to switch to remote control according to the PDU session parameter information corresponding to the second remote control mode.

### RELATED APPLICATIONS

The present application is a continuation of International Application No. PCT/CN2022/095144 filed on May 26, 2022, which claims priority to Chinese Patent Application No. 202110749253.9, filed on Jul. 1, 2021, and entitled “COMMUNICATION METHOD AND APPARATUS APPLIED TO REMOTE DRIVING, MEDIUM, AND ELECTRONIC DEVICE.” The entire disclosures of the prior applications are hereby incorporated by reference.

### FIELD OF THE TECHNOLOGY

This disclosure relates to the field of computers and communication technologies, including to a communication method and apparatus applied to remote driving, a medium, and an electronic device.

### BACKGROUND OF THE DISCLOSURE

Remote driving includes technology for implementing control on a vehicle by using long distance mobile communication, and is an important means to solve the problem of working in a dangerous and harsh environment (for example, earthquake relief, a toxic environment, a dangerous tunnel, fire-fighting and rescue, cliff path opening, or explosion site cleaning). With the development of 5G networks, strong support is provided for this low-delay driving manner.

In the related art, the basic principle of remote driving is to transmit driving instructions to a vehicle terminal in a downlink direction through a network, while the premise of transmitting the driving instructions is to transmit state parameters and visual information of the vehicle terminal to a remote driving terminal in an uplink direction through the network. In addition, remote driving also includes a plurality of driving modes, for example, a human remote control (HRC) mode and a machine remote control (MRC) mode. However, currently, there is no complete solution for switching between the remote driving modes.

### SUMMARY

Embodiments of this disclosure provide a communication method and apparatus applied to remote driving, a non-transitory computer-readable storage medium, and an electronic device, which can further resolve the problem of remote driving mode switching in a process of remote driving at least to a certain extent, so that the remote driving can more flexibly adapt to complex road working conditions and network conditions.

Other features and advantages of this disclosure will become apparent through the following detailed description.

According to an aspect of the embodiments of this disclosure, a method for remotely controlling a vehicle is provided. In the method, protocol data unit (PDU) session parameter information corresponding to a plurality of remote control modes of the vehicle is obtained by a session management function entity. The plurality of remote control modes includes a first remote control mode and a second remote control mode. While the vehicle is controlled according to the PDU session parameter information corresponding to the first remote control mode, mode switching information is received from an application function entity by the session management function entity. The mode switching information indicates the first remote control mode is to be switched to the second remote control mode. Based on the mode switching information, the vehicle is controlled by the session management function entity to switch to remote control according to the PDU session parameter information corresponding to the second remote control mode.

According to an aspect of the embodiments of this disclosure, a method for remotely controlling a vehicle is provided. In the method, protocol data unit (PDU) session parameter information corresponding to a plurality of remote control modes of the vehicle is determined by an application function entity. The plurality of remote control modes includes a first remote control mode and a second remote control mode. While the vehicle is remotely controlled according to the PDU session parameter information corresponding to the first remote control mode, mode switching information is transmitted by the application function entity to a core network element when the vehicle is to switch from the first remote control mode to the second remote control mode. The mode switching information indicates to the core network element that the vehicle is to switch to remote control according to the PDU session parameter information corresponding to the second remote control mode

According to an aspect of the embodiments of this disclosure, an apparatus for remotely controlling a vehicle is provided. The apparatus includes processing circuitry that is configured to obtain protocol data unit (PDU) session parameter information corresponding to a plurality of remote control modes of the vehicle. The plurality of remote control modes includes a first remote control mode and a second remote control mode. The processing circuitry is configured to receive, while the vehicle is controlled according to the PDU session parameter information corresponding to the first remote control mode, mode switching information from an application function entity. The mode switching information indicates the first remote control mode is to be switched to the second remote control mode. The processing circuitry is configured to control, based on the mode switching information, the vehicle to switch to remote control according to the PDU session parameter information corresponding to the second remote control mode.

According to an aspect of the embodiments of this disclosure, an apparatus for remotely controlling a vehicle is provided. The apparatus includes processing circuitry that is configured to determine protocol data unit (PDU) session parameter information corresponding to a plurality of remote control modes of the vehicle. The plurality of remote control modes includes a first remote control mode and a second remote control mode. The processing circuitry is configured to transmit, while the vehicle is remotely controlled according to the PDU session parameter information corresponding to the first remote control mode, mode switching information to a core network element when the vehicle is to switch from the first remote control mode to the second remote control mode. The mode switching information indicates to the core network element that the vehicle is to switch to remote control according to the PDU session parameter information corresponding to the second remote control mode.

According to an aspect of the embodiments of this disclosure, a non-transitory computer-readable storage medium is provided, storing a computer program, the computer program, when executed by at least one processor, implementing any of the methods described in the above embodiments.

According to an aspect of the embodiments of this disclosure, an electronic device is provided, including: one or more processors; and a storage apparatus, configured to store one or more programs, the one or more programs, when executed by the one or more processors, causing the one or more processors to implement the any of the methods described in the above embodiments.

According to an aspect of the embodiments of this disclosure, a computer program product or computer program is provided, the computer program product or computer program including computer instructions, the computer instructions being stored in a computer-readable storage medium. A processor of a computer device reads the computer instructions from the computer-readable storage medium, and the processor executes the computer instructions, so that the computer device performs any of the methods provided in the embodiments described above.

In the technical solutions provided in some embodiments of this disclosure, the PDU session parameters corresponding to the plurality of remote driving modes of the vehicle terminal are obtained, when the vehicle terminal is controlled to perform remote driving by using the PDU session parameter corresponding to the first remote driving mode, if the mode switching information transmitted by the application function entity is received, the vehicle terminal is controlled, based on the mode switching information, to switch to perform remote driving by using the PDU session parameter corresponding to the second remote driving mode, so that the problem of switching between the remote driving modes in the remote driving process can be resolved, and further the remote driving can more flexibly adapt to complex road working conditions and network conditions.

It is to be understood that the above general description and the following detailed description are exemplary and explanatory only, and are not intended to limit this disclosure.

### BRIEF DESCRIPTION OF THE DRAWINGS

The accompanying drawings which are incorporated in and constitute a part of the specification illustrate embodiments consistent with this application and together with the description serve to explain the principles of this disclosure. The drawings described below are only some embodiments of this disclosure, and other embodiments are within the scope of the present disclosure.

FIG. 1 shows a schematic diagram of an exemplary system architecture to which a technical solution according to an embodiment of this disclosure is applicable.

FIG. 2 shows a flowchart of a communication method applied to remote driving according to some embodiments of this disclosure.

FIG. 3 shows a flowchart of a communication method applied to remote driving according to some embodiments of this disclosure.

FIG. 4 shows a flowchart of a communication method applied to remote driving according to some embodiments of this disclosure.

FIG. 5 shows a schematic diagram of a PDU session switching process when switching from an HRC mode to an MRC mode according to some embodiments of this disclosure.

FIG. 6 shows a schematic diagram of a QoS parameter switching process when switching from an HRC mode to an MRC mode according to some embodiments of this disclosure.

FIG. 7 shows a schematic diagram of QoS parameters of an HRC mode and an MRC mode according to some embodiments of this disclosure.

FIG. 8 shows a schematic diagram of QoS parameters of an HRC mode and an MRC mode according to some embodiments of this disclosure.

FIG. 9 shows a block diagram of a communication apparatus applied to remote driving according to some embodiments of this disclosure.

FIG. 10 shows a block diagram of a communication apparatus applied to remote driving according to some embodiments of this disclosure.

FIG. 11 shows a schematic structural diagram of a computer system adapted to implement an electronic device according to an embodiment of this disclosure.

### DESCRIPTION OF EMBODIMENTS

Exemplary embodiments will now be described with reference to the accompanying drawings. However, embodiments can be implemented in various forms and shall not be construed as being limited to these examples.

Furthermore, the features, structures, or characteristics described herein may be incorporated in any suitable manner in one or more embodiments. In the following description there are many exemplary details so that the embodiments of this disclosure can be better understood. However, it will be appreciated by those skilled in the art that all the detailed features of the embodiments may not be required, one or more specific details may be omitted, or other methods, elements, devices, steps, etc. may be employed in implementing the technical aspects of this disclosure.

The block diagrams shown in the drawings are merely functional entities and do not necessarily correspond to physically independent entities. That is, the functional entities may be implemented in software, in processing circuitry such as one or more hardware modules or integrated circuits, or in different networks and/or processor devices and/or microcontroller devices.

The flowcharts shown in the accompanying drawings are merely exemplary descriptions and do not necessarily include all of the content and operations/steps, nor are the flowcharts necessarily performed in the order described. For example, some operations/steps can also be decomposed, while others can be merged or partially merged, so the actual order of execution may be changed according to the actual situation.

The term “plurality of” mentioned in this specification means two or more. The term “and/or” describes an association relationship between associated objects, and represents that three relationships may exist, for example, A and/or B may represent that, only A exists, both A and B exist, and only B exists. The character “/” generally indicates that the related objects are an “or” relationship.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

An autonomous driving technology relies on cooperation of artificial intelligence, visual computing, a radar system, a monitoring apparatus system, and a global positioning system, so that a computer can automatically and safely operate a motor vehicle without any active human operation. The autonomous driving technology usually includes high-precision maps, environment perception, behavior decision-making, path planning, motion control, and other technologies. The self-determined driving technology has a wide range of application prospects.

Remote driving is a technology between autonomous driving and manual driving, and remote driving is a technology that controls a vehicle by using long distance mobile communication, which may include a manual remote control (HRC) mode and a machine remote control (MRC) mode. As the name implies, HRC is manually performing remote driving, MRC is performing remote driving by a machine, and MRC is an example of autonomous driving.

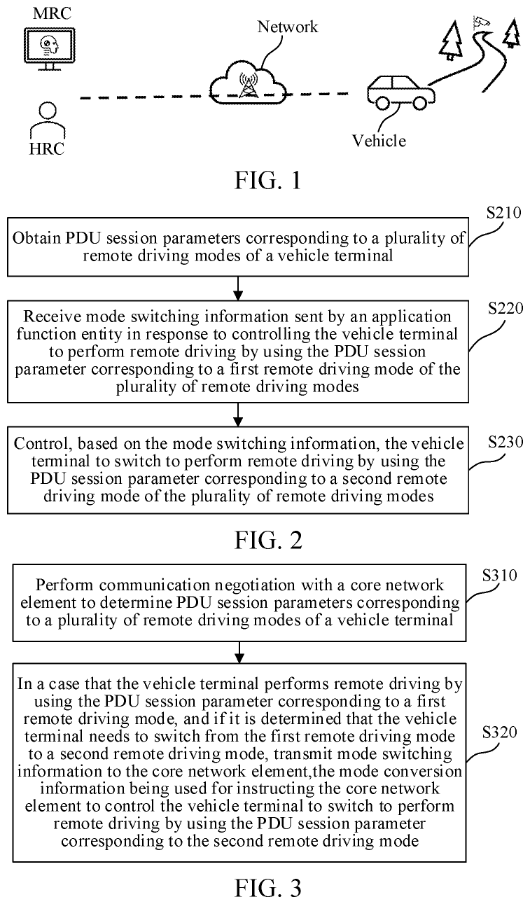

As shown in FIG. 1, in a remote driving scenario of this disclosure, there may be two remote driving modes, one is an MRC mode, and the other is an HRC mode. In the HRC mode, a driver may need to obtain video information in the field of vision of a remote vehicle through a network, and therefore, higher network bandwidth is required. In the MRC mode, information on a vehicle terminal can be transmitted by using structured data or original format data, and therefore, network bandwidth occupied is lower. Downlink control instructions have similar network transmission requirements for the HRC and MRC modes.

For a 5G system, the challenge of uplink transmission is greater than that of downlink transmission, especially for 5G remote driving. Because driving safety is involved, requirements for network data transmission are higher. In addition, 5G remote driving requires high jitter characteristics of network transmission, this is because jitter may affect an algorithm design of the vehicle terminal and cloud. Based on this, in a process of controlling a vehicle in a remote driving mode, it may be necessary to switch to another remote driving mode, for example, switching from MRC to HRC or from HRC to MRC, due to the influence of a network state or road conditions.

Based on a service requirement of switching between the remote driving modes, embodiments of this disclosure provide a switching processing scheme. Specifically, a network side (such as a core network element) can obtain PDU session parameters corresponding to a plurality of remote driving modes of a vehicle terminal, for example, the PDU session parameters can be determined through communication negotiation with an application function (AF). Furthermore, when the vehicle terminal is controlled on the network side to perform remote driving by using the PDU session parameter corresponding to the first remote driving mode, if mode switching information transmitted by the AF is received, the vehicle terminal can be controlled to switch to perform remote driving by using the PDU session parameter corresponding to the second remote driving mode based on the mode switching information.

In some embodiments, if the vehicle terminal performs remote driving in the MRC mode, and if the AF senses that the vehicle terminal is about to pass through complex road conditions and requires manual intervention, the MRC mode can be switched to the HRC mode by transmitting the mode switching information. In another example, if the vehicle terminal performs remote driving in the HRC mode, and if the AF senses that the vehicle terminal is about to pass through an area with poor network state, it can switch the HRC mode to the MRC mode by transmitting the mode switching information, so as to avoid possible driving risks caused by using the HRC mode when the network state is poor.

It can be seen that the technical solution of the embodiments of this disclosure can help address the problem of remote driving mode switching in the remote driving process, so that the remote driving can more flexibly adapt to complex road working conditions and network conditions.

Exemplary implementation details of the technical scheme of the embodiments of this disclosure are described in detail below

FIG. 2 shows a flowchart of a communication method applied to remote driving according to some embodiments of this disclosure. The communication method applied to remote driving may be performed by a core network element, and the core network element may be, for example, a session management function (SMF). Referring to FIG. 2, the communication method applied to remote driving includes at least steps S210 to S230, which are described in detail as follows:

In step S210, PDU session parameters corresponding to a plurality of remote driving modes of a vehicle terminal are obtained.

In some embodiments of this disclosure, the plurality of remote driving modes include a first remote driving mode and a second remote driving mode, where the first remote driving mode may be one of the MRC mode and the HRC mode, and the second remote driving mode may be the other of the MRC mode and the HRC mode. The PDU session parameters corresponding to the remote driving modes may be determined by communication and interaction between the AF and a policy control function (PCF). In this case, the AF can communicate with PCF through a network exposure function (NEF). Alternatively, when the AF is in a trusted network environment, the AF can communicate with the PCF directly.

In some embodiments, the PDU session parameter include a QoS parameter, where the QoS parameter may include an uplink QoS parameter and a downlink QoS parameter. Uplink QoS parameters corresponding to the plurality of remote driving modes may be different. For example, for HRC and MRC, because data types and data volumes of uplink transmission are different, corresponding uplink QoS parameters are also different. However, for the downlink QoS parameter, downlink QoS parameters corresponding to the plurality of remote driving modes may be the same or different.

In step S220, when the vehicle terminal is controlled to perform remote driving by using the PDU session parameter corresponding to the first remote driving mode, the mode switching information transmitted by the application function entity is received.

In some embodiments of this disclosure, the application function entity may transmit mode switching information to the core network element when sensing that the road condition information and/or network state information of the road section traveled by the vehicle terminal has changed (or is about to change).

In some embodiments, the mode switching information transmitted by the application function entity indicates switching from a first remote driving mode to a second remote driving mode. For example, when the vehicle terminal performs remote driving in the MRC mode, if the AF senses that the vehicle terminal is about to pass through complex road conditions and needs manual intervention, it can switch the MRC mode to the HRC mode by transmitting the mode switching information. In another example, when the vehicle terminal performs remote driving in the HRC mode, if the AF senses that the vehicle terminal is about to pass through an area with poor network state, it can switch the HRC mode to the MRC mode by transmitting the mode switching information, so as to avoid possible driving risks caused by still using the HRC mode when the network state is poor.

In some embodiments of this disclosure, before receiving the mode switching information transmitted by the application function entity, the core network element can control the vehicle terminal to establish PDU sessions corresponding to a plurality of remote driving modes according to PDU session parameters corresponding to a plurality of remote driving modes respectively. According to the technical solution of the embodiment, PDU sessions corresponding to each remote driving mode can be established in advance, so that the switching of the driving mode can be realized as soon as possible when the switching of the remote driving mode is needed.

In some embodiments of this disclosure, the core network element needs to maintain the PDU session corresponding to the second remote driving mode in an active state before controlling the vehicle terminal to switch to perform remote driving by using the PDU session parameter corresponding to the second remote driving mode, so as to reduce the time spent in switching the remote driving mode.

In some embodiments of this disclosure, when establishing a PDU session for the remote driving mode, the core network element can control the vehicle terminal to establish the same PDU session for a plurality of remote driving modes and respectively use different PDU session parameters for the plurality of remote driving modes. Alternatively, the core network element can also control the vehicle terminal to establish different PDU sessions for the plurality of remote driving modes, and use different PDU session parameters for the plurality of remote driving modes.

In step S230, the vehicle terminal is controlled to switch to perform remote driving by PDU session parameter corresponding to the second remote driving mode based on the mode switching information.

In some embodiments of this disclosure, if different PDU sessions are established for the second remote driving mode and the first remote driving mode, switching processing of the PDU session is required at the time of switching, i.e. switching a PDU session for transmitting remote driving data, and adjusting corresponding PDU session parameters, etc.

In some embodiments of this disclosure, if the same PDU session is established for the second remote driving mode and the first remote driving mode, handover processing of the PDU session is not required at the time of handover, but adjustment of PDU session parameters is required.

In some embodiments of this disclosure, after controlling the vehicle terminal to switch to perform remote driving by using the PDU session parameter corresponding to the second remote driving mode, the core network element can transmit the PDU session parameters switched by the vehicle terminal to the application function entity, and then the application function entity can transmit a remote control instruction to the vehicle terminal accordingly.

In some embodiments of this disclosure, the process of negotiating PDU session parameters corresponding to the remote driving mode between the PCF and the AF may be performed before the remote driving is performed, for example, before the core network element controls the vehicle terminal to perform remote driving by using the PDU session parameter corresponding to the first remote driving mode, the communication negotiation is performed by the AF and the PCF, and the PDU session parameter corresponding to the first remote driving mode and the second remote driving mode respectively are determined.

Of course, before the core network element controls the vehicle terminal to perform remote driving by using the PDU session parameter corresponding to the first remote driving mode, only the PDU session parameter corresponding to the first remote driving mode can be negotiated between the AF and the PCF, but the PDU session parameter corresponding to the second remote driving mode may need to be negotiated between the AF and the PCF before switching, that is, in the process of performing remote driving by using the PDU session parameter corresponding to the first remote driving mode.

The technical solution of the embodiment shown in FIG. 2 is described from the perspective of core network elements, and the implementation details of the technical solution of the embodiments of this disclosure are described from the perspective of the AF with reference to FIG. 3:

FIG. 3 shows a flowchart of a communication method applied to remote driving according to some embodiments of this disclosure. The communication method applied to remote driving may be performed by an AF. Referring to FIG. 3, the communication method applied to remote driving includes at least steps S310 to S320, which are described in detail as follows:

In step S310, communication negotiation is performed with the core network element to determine PDU session parameters corresponding to a plurality of remote driving modes of a vehicle terminal.

In some embodiments of this disclosure, PDU session parameters corresponding to each remote driving mode may be determined by communication interaction between the AF and the PCF. In this case, the AF can communicate with the PCF through NEF; Alternatively, when the AF is in a trusted network environment, the AF can communicate with the PCF directly.

In some embodiments, PDU session parameters include QoS parameters. Uplink QoS parameters corresponding to the plurality of remote driving modes may be different. For example, for HRC and MRC, because data types and data volumes of uplink transmission are different, corresponding uplink QoS parameters are also different. However, for the downlink QoS parameter, downlink QoS parameters corresponding to the plurality of remote driving modes may be the same or different.

In step S320, when the vehicle terminal performs remote driving by using the PDU session parameter corresponding to the first remote driving mode among the plurality of remote driving modes, if it is determined that the vehicle terminal needs to switch from the first remote driving mode to the second remote driving mode, mode switching information is transmitted to the core network element, and the mode switching information is used for instructing the core network element to control the vehicle terminal to switch to perform remote driving by using the PDU session parameter corresponding to the second remote driving mode.

Specifically, in the process of remote driving by the manual remote control mode at the vehicle terminal, if the AF determines that the driving section is suitable for the machine remote control mode according to the road condition information and the network state information of the driving road section at the vehicle terminal, it determines that the vehicle terminal can switch from the manual remote control mode to the machine remote control mode. For example, if the AF senses that the vehicle terminal driven by manual remote driving is about to pass through the area with poor network state, and the area is suitable for machine remote driving, it can be determined that the vehicle terminal can be switched from manual remote control mode to machine remote control mode, so as to avoid possible driving risks caused by using the HRC mode when the network state is poor.

In the process of remote driving by the machine remote control mode at the vehicle terminal, if it is determined that the driving road section is not suitable for the machine remote control mode according to the road condition information and network state information of the driving road section at the vehicle terminal, it is determined that the vehicle terminal needs to switch from the machine remote control mode to the manual remote control mode. For example, if the AF senses that the vehicle terminal driven remotely by the machine is about to pass through complex road conditions and needs manual intervention, it can be determined that the vehicle terminal can be switched from the machine remote control mode to the manual remote control mode.

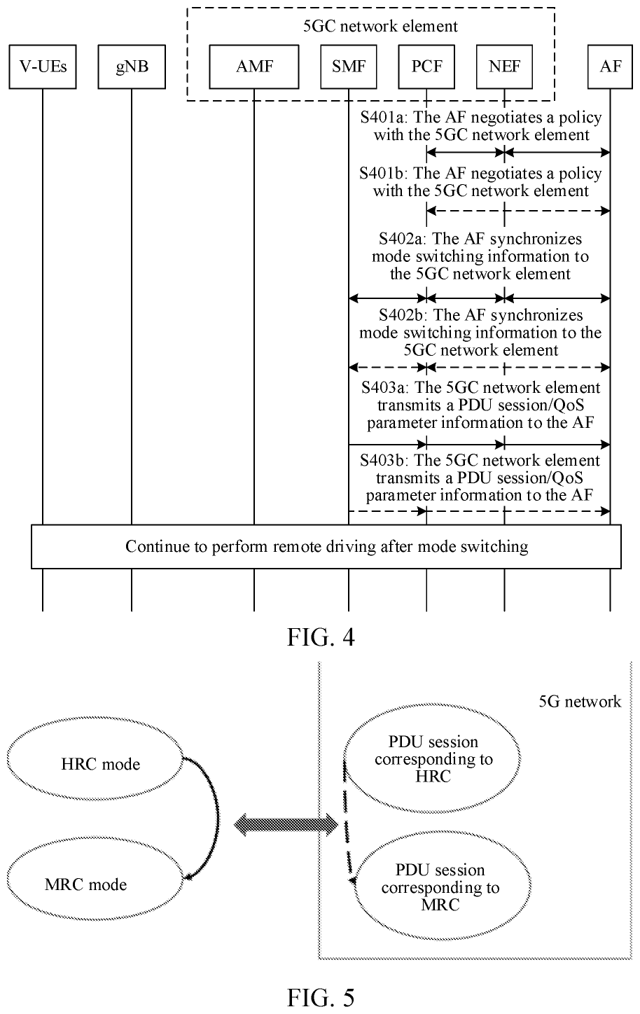

The technical scheme of the embodiments of this disclosure is described above from the perspective of the core network element and the AF respectively. Taking HRC and MRC remote driving modes as examples, the implementation details of the technical scheme of the embodiments of this disclosure are described in detail in combination with FIG. 4 to FIG. 8:

In an embodiment of this disclosure, negotiation interaction can be performed between the AF and 5G Core (5GC) network elements to negotiate PDU session parameters for two modes of remote driving application (that is, HRC and MRC).

Specifically, as shown in FIG. 4, the negotiation process between the AF and the 5GC network element may be performed through step S401a or step S401b. In step S401a, the AF can perform negotiation processing between the NEF and the PCF; In step S401b, the AF can directly negotiate with the PCF.

Considering the service requirements of remote driving, the HRC and MRC modes may be switched at any time, so it may not be possible to wait until the mode is switched before establishing a new PDU session or negotiating PDU session parameters. Instead, PDU sessions should be established for these two remote driving modes before switching, and PDU session parameters should be negotiated.

In some embodiments, the HRC and MRC may establish different PDU sessions to meet the needs of the HRC and MRC, an approach that may be appropriate for scenarios such as where the HRC and MRC are respectively applied to different servers (or server farms).

Of course, HRC and MRC can also establish a same PDU session, but different PDU session parameters can be set for the HRC and MRC modes, for example, a QoS profile.

In the process of remote driving, if the road condition of the road section where the vehicle travels permits and the network quality meets the corresponding driving mode requirements, the remote driving mode can be switched from HRC to MRC, or from MRC to HRC.

Specifically, as shown in FIG. 4, when mode switching is required, the mode switching information can be synchronized to the 5GC by step S402a or step S402b. In step S402a, the AF can synchronize the mode switching information with the SMF through the NEF and PCF; In step S402b, the AF can directly synchronize the mode switching information with the SMF through the PCF.

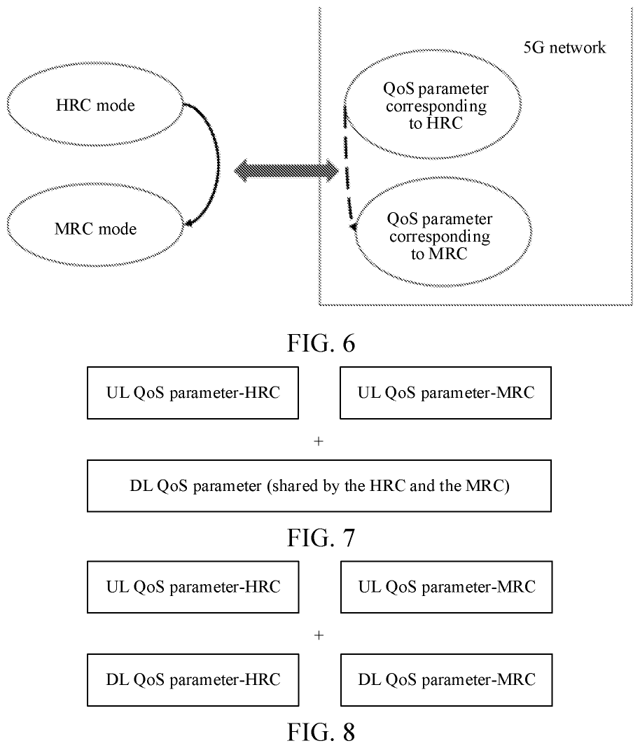

As shown in FIG. 5, when the remote driving mode is switched from the HRC mode to the MRC mode, the PDU session of the 5G network is switched from the PDU session corresponding to HRC to the PDU session corresponding to MRC. As shown in FIG. 6, when the remote driving mode is switched from the HRC mode to the MRC mode, the QoS parameters of 5G network change from the QoS parameters corresponding to HRC to the QoS parameters corresponding to MRC.

In some embodiments of this disclosure, in a manner in which the MRC mode and the HRC mode employ different PDU sessions, the PDU sessions of the MRC mode and the HRC mode are associated with a series of parameters, including but not limited to single network slice selection assistance information (S-NSSAI) in the HRC mode or the MRC mode, a data network name (DNN), QoS parameters of a radio bearer and the core network bearer corresponding to the PDU session, and/or the like. In addition, the vehicle terminal needs to ensure that the PDU sessions corresponding to the two remote driving modes are maintained in an active state, or need to be established and/or activated before the mode switching.

In some embodiments, the MRC mode and the HRC mode employ different QoS parameters/profiles, and the QoS parameters corresponding to each mode include, but are not limited to, bandwidth, delay, jitter, packet loss rate, and/or the like.

As shown in FIG. 7, the MRC mode and the HRC mode can configure separate uplink (UL) QoS parameters, but share the same downlink (DL) QoS parameters. Alternatively, as shown in FIG. 8, the MRC mode and the HRC mode can not only configure independent UL QoS parameters, but also independent DL QoS parameters.

In FIG. 4, after performing the mode switching, the core network element may transmit the switched PDU session/QoS parameter information to the AF through step S403a or step S403b. In step S403a, the SMF transmits the switched PDU session/QoS parameter information to the AF through the PCF and the NEF. In step S403b, the SMF directly transmits the switched PDU session/QoS parameter information to the AF through the PCF. After the mode is switched, remote driving can be continued based on the switched remote driving mode.

To sum up, the technical scheme of the embodiments of this disclosure can resolve the adaptation problem of 5G network characteristics when the mode switching of remote driving occurs, so that the 5G remote driving scheme can flexibly adapt to complex road conditions and network conditions.

Embodiments of the apparatus of this disclosure are described below, which may be used to perform the communication method applied to remote driving in the above-described embodiments of this disclosure. For examples of details not disclosed in the embodiment of the apparatus of this disclosure, reference may be made to the above embodiment of the communication method applied to remote driving of this disclosure.

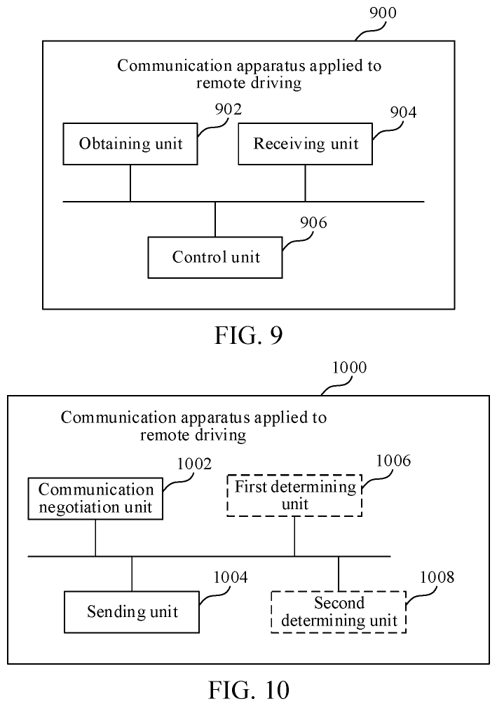

FIG. 9 shows a block diagram of a communication apparatus applied to remote driving according to some embodiments of this disclosure. The communication apparatus applied to remote driving may be configured in a core network element, and the core network element may be, for example, an SMF.

Referring to FIG. 9, a communication apparatus 900 applied to remote driving according to some embodiments of this disclosure includes: an obtaining unit 902, a receiving unit 904, and a control unit 906.

The obtaining unit 902 is configured to obtain PDU session parameters corresponding to a plurality of remote driving modes of a vehicle terminal, the plurality of remote driving modes including a first remote driving mode and a second remote driving mode; the receiving unit 904 is configured to receive mode switching information transmitted by the application function entity when controlling the vehicle terminal to perform remote driving by using the PDU session parameter corresponding to the first remote driving mode, the mode switching information being used for instructing to switch from the first remote driving mode to the second remote driving mode; and the control unit 906 is configured to control, based on the mode switching information, the vehicle terminal to switch to perform remote driving by using the PDU session parameter corresponding to the second remote driving mode.

In some embodiments of this disclosure, based on the foregoing solution, the control unit 906 is further configured to: before receiving the mode switching information transmitted by the application function entity, control the vehicle terminal to establish PDU sessions corresponding to the plurality of remote driving modes based on the PDU session parameters respectively corresponding to the plurality of remote driving modes.

In some embodiments of this disclosure, based on the foregoing solution, the control unit 906 is further configured to: maintain a PDU session corresponding to the second remote driving mode in an active state before controlling the vehicle terminal to switch to perform remote driving by using the PDU session parameter corresponding to the second remote driving mode.

In some embodiments of this disclosure, based on the foregoing solution, the control unit 906 is configured to: control the vehicle terminal to establish a same PDU session for the plurality of remote driving modes and respectively use different PDU session parameters for the plurality of remote driving modes.

In some embodiments of this disclosure, based on the foregoing solution, the control unit 906 is configured to: control the vehicle terminal to respectively establish different PDU sessions for the plurality of remote driving modes and respectively use different PDU session parameters for the plurality of remote driving modes.

In some embodiments of this disclosure, based on the foregoing solution, the PDU session parameter includes a QoS parameter; the QoS parameter includes an uplink QoS parameter and a downlink QoS parameters. Uplink QoS parameters corresponding to the plurality of remote driving modes are different. Downlink QoS parameters corresponding to the plurality of remote driving modes are the same or different.

In some embodiments of this disclosure, based on the foregoing solution, the control unit 906 is further configured to: after controlling the vehicle terminal to switch to perform remote driving by using the PDU session parameter corresponding to the second remote driving mode, transmit the PDU session parameters switched by the vehicle terminal to the application function entity, where the application function entity transmits a remote control instruction to the vehicle terminal based on the received PDU session parameter.

In some embodiments of this disclosure, based on the foregoing solution, the PDU session parameters corresponding to the first remote driving mode and the second remote driving mode are respectively determined by the policy control function entity and the application function entity through communication negotiation before controlling the vehicle terminal to perform remote driving by using the PDU session parameter corresponding to the first remote driving mode.

In some embodiments, the PDU session parameter corresponding to the first remote driving mode is determined by performing communication negotiation between a policy control function entity and the application function entity before the controlling the vehicle terminal to perform remote driving by using the PDU session parameter corresponding to the first remote driving mode, and the PDU session parameter corresponding to the second remote driving mode is determined by performing communication negotiation between the policy control function entity and the application function entity during the controlling the vehicle terminal to perform remote driving by using the PDU session parameter corresponding to the first remote driving mode.

FIG. 10 shows a block diagram of a communication apparatus applied to remote driving according to some embodiments of this disclosure. The communication apparatus applied to remote driving may be configured in the AF.

Referring to FIG. 10, a communication apparatus 1000 applied to remote driving according to some embodiments of this disclosure includes: a communication negotiation unit 1002 and a transmitting unit 1004.

The communication negotiation unit 1002 is configured to perform communication negotiation with the core network elements to determine PDU session parameters corresponding to a plurality of remote driving modes of a vehicle terminal. The plurality of remote driving modes includes a first remote driving mode and a second remote driving mode. The transmitting unit 1004 is configured to transmit mode switching information to the core network element if it is determined that the vehicle terminal needs to switch from the first remote driving mode to the second remote driving mode when the vehicle terminal performs remote driving by using the PDU session parameter corresponding to the first remote driving mode, and the mode switching information is used for instructing the core network element to control the vehicle terminal to switch to perform remote driving by using the PDU session parameter corresponding to the second remote driving mode.

In some embodiments of this disclosure, the first remote driving mode is any one of a machine remote control mode and a manual remote control mode, and the second remote driving mode is the other of the machine remote control mode and the manual remote control mode based on the foregoing scheme. The communication apparatus 1000 further includes a first determining unit 1006, configured to, in a case that the vehicle terminal performs remote driving in the manual remote control mode, and if it is determined based on road condition information and network state information of a driving road section of the vehicle terminal, that the driving road section is suitable for the machine remote control mode, determining that the vehicle terminal is capable of switching from the manual remote control mode to the machine remote control mode.

In some embodiments of this disclosure, the first remote driving mode is any one of a machine remote control mode and a manual remote control mode, and the second remote driving mode is the other of the machine remote control mode and the manual remote control mode based on the foregoing scheme. The communication apparatus 1000 further includes a second determining unit 1008, configured to, in a case that the vehicle terminal performs remote driving in the machine remote control mode, and if it is determined, based on road condition information and network state information of a driving road section of the vehicle terminal, that the driving road section is not suitable for the machine remote control mode, determining that the vehicle terminal needs to switch from the machine remote control mode to the manual remote control mode.

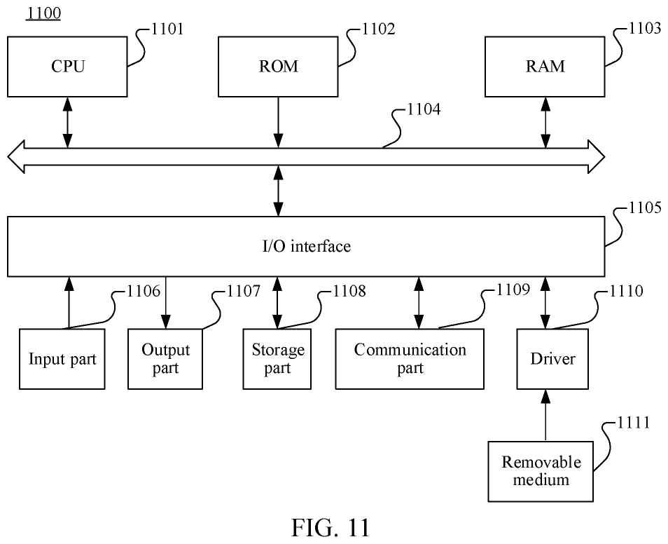

FIG. 11 shows a schematic structural diagram of a computer system adapted to implement an electronic device according to an embodiment of this disclosure.

The computer system 1100 of an electronic device shown in FIG. 11 is only one example and does not constitute any limitation on the function and scope of use of the embodiments of this disclosure.

As shown in FIG. 11, the computer system 1100 includes a central processing unit (CPU) 1101 that can perform various appropriate actions and processes according to a program stored in a read-only memory (ROM) 1102 or a program loaded into a random access memory (RAM) 1103 from a storage section 1108, such as performing the methods described in the above-described embodiments. The RAM 1103 further stores various programs and data required for system operations. The CPU 1101, the ROM 1102, and the RAM 1103 are connected to each other through a bus 1104. An input/output (I/O) interface 1105 is also connected to the bus 1104.

The following components are connected to the I/O interface 1105: an input section 1106 including a keyboard a mouse and/or the like; an output section 1107 including a cathode ray tube (CRT), a liquid crystal display (LCD), and/or the like, and a speaker; a storage section 1108 including a hard disk or the like; and a communication section 1109 including a network interface card such as a local area network (LAN) card a modem and/or the like. The communication portion 1109 performs communication processing by using a network such as the Internet. A driver 1110 is also connected to the I/O interface 1105 as required. A removable medium 1111, such as a magnetic disk, an optical disc, a magneto-optical disk, or a semiconductor memory, is installed on the driver 1110 as required, so that a computer program read from the removable medium is installed into the storage part 1108 as required.

In particular, according to the embodiments of this disclosure, the process described above with reference to the flowchart may be implemented as a computer software program. For example, an embodiment of this disclosure provides a computer program product, including a computer program carried on a computer-readable medium, where the computer program includes a computer program for performing the method shown in the flowchart. In such an embodiment, the computer program may be downloaded and installed from the network through the communication section 1109 and/or installed from the removable medium 1111. When the computer program is executed by a central processing unit (CPU) 1101 various functions defined in the system of this disclosure are performed.

The computer-readable medium shown in embodiments of this disclosure may be a computer-readable signal medium or a computer-readable storage medium or any combination of the above. The computer-readable storage medium may be, for example, but is not limited to, an electric, magnetic, optical, electromagnetic, infrared, or semi-conductive system, apparatus, or component, or any combination thereof. More specific examples of the computer readable storage medium may include, but are not limited to: a portable computer disk, a hard disk, a random access memory (RAM), a read-only memory (ROM), an erasable programmable read only memory (EPROM), a flash memory, an optical fiber, a portable compact disc read-only memory (CD-ROM), an optical memory device, a magnetic memory device, or any suitable combination of the above. In this disclosure, the computer-readable storage medium may be any tangible medium (such as a non-transitory computer-readable storage medium) including or storing a program that may be used by or used in combination with an instruction execution system, apparatus, or device. In this disclosure, the computer-readable signal medium may include a data signal propagated in the baseband or as part of a carrier wave, in which a computer-readable computer program is carried. The data signal propagated in such a way may assume a plurality of forms, including, but not limited to, an electromagnetic signal, an optical signal, or any appropriate combination thereof. The computer-readable signal medium may also be any computer-readable medium other than a computer-readable storage medium that may transmit, propagate, or transmit a program for use by or in conjunction with an instruction execution system, apparatus, or device. The computer program included in the readable storage medium may be transmitted using any suitable medium, including but not limited to: wireless, wired, etc., or any suitable combination of the above.

The flowcharts and block diagrams in the accompanying drawings illustrate possible system architectures, functions and operations that may be implemented by a system, a method, and a computer program product according to various embodiments of this disclosure. Each box in a flowchart or a block diagram may represent a module, a program segment, or a part of code. The module, the program segment, or the part of code includes one or more executable instructions used for implementing specified logic functions. In some alternative implementations the functions indicated in the boxes may also occur in a different order than those indicated in the drawings. For example, two blocks represented in succession can actually be executed substantially in parallel or they can sometimes be executed in reverse order depending on the functionality involved. Each box in a block diagram or a flowchart and a combination of boxes in the block diagram or the flowchart may be implemented by using a dedicated hardware-based system configured to perform a designated function or operation, or may be implemented by using a combination of dedicated hardware and a computer instruction.

The unit described in the embodiments of this disclosure may be implemented by software or hardware, and the described unit may also be arranged in a processor. Names of the units do not constitute a limitation on the units in a specific case.

In another aspect, this disclosure further provides a computer readable medium. The computer readable medium may be included in the electronic device described in the above embodiments, or may exist alone without being assembled into the electronic device. The computer-readable medium carries one or more programs, the one or more programs, when executed by the electronic device, causing the electronic device to implement the method described in the foregoing embodiments.

Although several modules or units of the apparatus for action execution are mentioned in the above detailed description, this division is not mandatory. Actually, according to the implementations of this disclosure, the features and functions of two or more modules or units described above may be specified in one module or unit. Conversely, the features and functions of one module or unit described above may be further divided to be embodied by a plurality of modules or units.

The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

According to the foregoing descriptions of the implementations, a person skilled in the art may readily understand that the exemplary implementations described herein may be implemented by using software, or may be implemented by combining software and necessary hardware. Therefore, the technical solutions of the embodiments of this disclosure may be implemented in a form of a software product. The software product may be stored in a non-volatile storage medium (which may be a CD-ROM, a USB flash drive, a removable hard disk, or the like) or on the network, including several instructions for instructing a computing device (which may be a personal computer, a server, a touch terminal, a network device, or the like) to perform the methods according to the embodiments of this disclosure.

After considering the specification and practicing the disclosed implementations, it should be understood that other implementations are within the scope of this disclosure. This disclosure is intended to cover any variations, uses, or adaptive changes of this disclosure following the general principles of this disclosure.

This disclosure is not limited to the specific structures that are described above and that are shown in the accompanying drawings, and modifications and changes may be made without departing from the scope of this disclosure.

What is claimed is:

1. A method for remotely controlling a vehicle, the method comprising:
obtaining, by a session management function entity, protocol data unit (PDU) session parameter information corresponding to a plurality of remote control modes of the vehicle, the plurality of remote control modes including a first remote control mode and a second remote control mode;
receiving, by the session management function entity while the vehicle is controlled according to the PDU session parameter information corresponding to the first remote control mode, mode switching information from an application function entity, the mode switching information indicating the first remote control mode is to be switched to the second remote control mode; and
controlling, by the session management function entity based on the mode switching information, the vehicle to switch to remote control according to the PDU session parameter information corresponding to the second remote control mode.

2. The method according to claim 1, wherein
the first remote control mode is a manual remote driving mode, and
the second remote control mode is a machine remote driving mode.

3. The method according to claim 1, further comprising:
controlling, by the session management function entity, the vehicle to establish at least one PDU session for the plurality of remote control modes based on the PDU session parameter information corresponding to the plurality of remote control modes.

4. The method according to claim 3, further comprising:
maintaining, by the session management function entity, the PDU session corresponding to the second remote control mode in an active state before the vehicle is controlled to switch to the remote control according to the PDU session parameter information corresponding to the second remote control mode.

5. The method according to claim 3, wherein the controlling the vehicle to establish the at least one PDU session comprises:
controlling, by the session management function entity, the vehicle to establish a same PDU session for the plurality of remote control modes, the PDU session parameter information of the same PDU session being different for the plurality of remote control modes.

6. The method according to claim 3, wherein the controlling the vehicle to establish the at least one PDU session comprises:
controlling, by the session management function entity, the vehicle to establish different PDU sessions for the plurality of remote control modes according to different PDU session parameter information for the plurality of remote control modes.

7. The method according to claim 1, wherein the PDU session parameter information for each of the plurality of remote control modes includes quality of service (QoS) parameter information, the QoS parameter information including an uplink QoS parameter and a downlink QoS parameter; and
the uplink QoS parameters corresponding to the plurality of remote control modes are different.

8. The method according to claim 1, further comprising:
transmitting, by the session management function entity, the PDU session parameter information for the switch by the vehicle to the application function entity after the vehicle is controlled to switch to remote control according to the PDU session parameter information corresponding to the second remote control mode,
wherein the application function entity transmits a remote control instruction to the vehicle based on the received PDU session parameter information.

9. The method according to claim 1, wherein
the PDU session parameter information corresponding to the first remote control mode and the second remote control mode are respectively determined by a policy control function entity and the application function entity before the vehicle is remotely controlled according to the PDU session parameter information corresponding to the first remote control mode.

10. The method according to claim 1, wherein
the PDU session parameter information corresponding to the first remote control mode is determined before the vehicle is remotely controlled according to the PDU session parameter information corresponding to the first remote control mode, and
the PDU session parameter information corresponding to the second remote control mode is determined while the vehicle is remotely controlled with the PDU session parameter information corresponding to the first remote control mode.

11. A method for remotely controlling a vehicle, the method comprising:
determining, by an application function entity, protocol data unit (PDU) session parameter information corresponding to a plurality of remote control modes of the vehicle, the plurality of remote control modes including a first remote control mode and a second remote control mode; and
transmitting, by the application function entity while the vehicle is remotely controlled according to the PDU session parameter information corresponding to the first remote control mode, mode switching information to a core network element when the vehicle is to switch from the first remote control mode to the second remote control mode, the mode switching information indicating to the core network element that the vehicle is to switch to remote control according to the PDU session parameter information corresponding to the second remote control mode.

12. The method according to claim 11, wherein
the first remote control mode is a manual remote driving mode, and
the second remote control mode is a machine remote driving mode.

13. The method according to claim 12, further comprising:
while the vehicle is remotely controlled in the manual remote driving mode, determining that the vehicle is to switch from the manual remote driving mode to the machine remote driving mode based on at least one of road condition information or network state information of a driving road segment of the vehicle.

14. The method according to claim 12, further comprising:
while the vehicle is remotely controlled in the machine remote driving mode, determining that the vehicle is to switch from the machine remote driving mode to the manual remote driving mode based on at least one of road condition information or network state information of a driving road segment of the vehicle.

15. An apparatus for remotely controlling a vehicle, the apparatus comprising:
processing circuitry configured to:
obtain protocol data unit (PDU) session parameter information corresponding to a plurality of remote control modes of the vehicle, the plurality of remote control modes including a first remote control mode and a second remote control mode;
receive, while the vehicle is controlled according to the PDU session parameter information corresponding to the first remote control mode, mode switching information from an application function entity, the mode switching information indicating the first remote control mode is to be switched to the second remote control mode; and
control, based on the mode switching information, the vehicle to switch to remote control according to the PDU session parameter information corresponding to the second remote control mode.

16. The apparatus according to claim 15, wherein
the first remote control mode is a manual remote driving mode, and
the second remote control mode is a machine remote driving mode.

17. The apparatus according to claim 15, wherein the processing circuitry is configured to:
control the vehicle to establish at least one PDU session for the plurality of remote control modes based on the PDU session parameter information corresponding to the plurality of remote control modes.

18. The apparatus according to claim 17, wherein the processing circuitry is configured to:
maintain the PDU session corresponding to the second remote control mode in an active state before the vehicle is controlled to switch to the remote control according to the PDU session parameter information corresponding to the second remote control mode.

19. The apparatus according to claim 17, wherein the processing circuitry is configured to:
control the vehicle to establish a same PDU session for the plurality of remote control modes, the PDU session parameter information of the same PDU session being different for the plurality of remote control modes.

20. The apparatus according to claim 17, wherein the processing circuitry is configured to:
control the vehicle to establish different PDU sessions for the plurality of remote control modes according to different PDU session parameter information for the plurality of remote control modes.
